(19) United States
(12) Patent Application Publication
(10) Pub. No.: US 2018/0088784 A1
(43) Pub. Date: Mar. 29, 2018

(54) Method and Device for Sharing Content

(71) Applicant: Beijing Xiaomi Mobile Software Co., Ltd., Beijing (CN)

(72) Inventors: Yin ZHU, Beijing (CN); Zhenzhou LU, Beijing (CN)

(73) Assignee: Beijing Xiaomi Mobile Software Co., Ltd., Beijing (CN)

(21) Appl. No.: 15/458,730

(22) Filed: Mar. 14, 2017

(30) Foreign Application Priority Data
Sep. 29, 2016 (CN) 201610865379.1

(51) Int. Cl. G06F 3/0484; G06F 3/0488; G06F 3/0481

(52) U.S. Cl. CPC G06F 3/04845; G06F 3/04842; G06F 3/04817; G06F 3/04883

(57) ABSTRACT

Methods and devices are provided for sharing content in the mobile internet technology field. In the method, the electronic device displays a content page including a plurality of content elements on the touch screen. In the content page, the electronic device obtains an operation signal of the user for triggering content sharing and enters a content sharing mode. The electronic device obtains a selection gesture identifying at least one content element from the plurality of content elements on the content page. The electronic device shares the at least one content element when detecting that the at least one content element are dragged to a predetermined area on the touch screen.

### CROSS REFERENCE TO RELATED APPLICATION

This application is based upon and claims priority to Chinese Patent Application Serial No. 201610865379.1, filed with the State Intellectual Property Office of P. R. China on Sep. 29, 2016, and titled with “method and device for sharing content”, the entire contents of which are incorporated herein by reference.

### TECHNICAL FIELD

The present disclosure relates to mobile internet technology field, and more particularly, to a method and a device for sharing content.

### BACKGROUND

With the fast development of the mobile internet technology, especially appearance of social media, users may forward and share content whenever and wherever by a social media platform. For instance, for a browsed web page, a user may realize overall sharing of the web page by forwarding a link address corresponding to the web page. However, in some scenarios, the user may only want to forward and share a paragraph of text, a picture, a video clip or other part of the content in the web page. For these scenarios, the present disclosure provides a new solution for sharing content.

### SUMMARY

In a first aspect of the present disclosure, a method for sharing content is provided, which may be implemented at least partially in an electronic apparatus including a touch screen. In the method, the electronic apparatus displays a content page including a plurality of content elements on the touch screen. In the content page, the electronic apparatus obtains an operation signal of the user for triggering content sharing and enters a content sharing mode. The electronic apparatus obtains a selection gesture identifying at least one content element from the plurality of content elements on the content page. The electronic apparatus shares the at least one content element when detecting that the at least one content element are dragged to a predetermined area on the touch screen.

In a second aspect of the present disclosure, a device for sharing content is provided and includes: a processor in communication with a touch screen and a memory for storing instructions executable by the processor. The processor is configured to: display a content page including a plurality of content elements on the touch screen; obtain an operation signal of the user for triggering content sharing in the content page, and enter a content sharing mode; obtain a selection gesture identifying at least one content element from the plurality of content elements on the content page, and share the content element when detecting that the at least one content element are dragged to a predetermined area on the touch screen.

In a third aspect of the present disclosure, a non-transitory computer-readable storage medium is provided. The non-transitory computer-readable storage medium has stored therein instructions that, when executed by a processor of a device, causes the device to perform acts for sharing content. The acts include: displaying a content page specified to open by a user; in the content page, obtaining an operation signal of the user for triggering content sharing, and entering a content sharing mode; and obtaining a content element selected by the user from the content page, and sharing the content element.

It is to be understood that both the foregoing general description and the following detailed description are exemplary and explanatory only and are not restrictive of the present disclosure.

### BRIEF DESCRIPTION OF THE DRAWINGS

Accompanying drawings herein are incorporated in and constitute a part of the specification, and illustrate exemplary embodiments in line with the present disclosure, and serve to explain the principle of the present disclosure together with the description.

FIG. 1 is a flow chart of a method for sharing content according to one or more exemplary embodiments of the present disclosure.

FIG. 2 is a flow chart of a method for sharing content according to one or more exemplary embodiments of the present disclosure.

FIG. 3A is a schematic diagram illustrating a display interface of a web page according to one or more exemplary embodiments of the present disclosure.

FIG. 3B is a schematic diagram illustrating a user triggering a currently displayed content page to enter a content sharing mode according to one or more exemplary embodiments of the present disclosure.

FIG. 4A is a schematic diagram illustrating a first operation of dragging a content element to a target application in displayed applications to share according to one or more exemplary embodiments of the present disclosure.

FIG. 4B is a schematic diagram illustrating a second operation of dragging a content element to a target application in displayed applications to share according to one or more exemplary embodiments of the present disclosure.

FIG. 4C is a schematic diagram illustrating a third operation of dragging a content element to a target application in displayed applications to share according to one or more exemplary embodiments of the present disclosure.

FIG. 5A is a schematic diagram illustrating an implementation procedure of a content element shared in a session page with a contact according to the present disclosure.

FIG. 5B is a schematic diagram illustrating an implementation procedure of a content element shared in a session page with a contact according to the present disclosure.

FIG. 5C is a schematic diagram illustrating an implementation procedure of a content element shared in a session page with a contact according to the present disclosure.

FIG. 5D is a schematic diagram illustrating an implementation procedure of a content element shared in a session page with a contact according to the present disclosure.

FIG. 5E is a schematic diagram illustrating an implementation procedure of a content element shared in a session page with a contact according to the present disclosure.

FIG. 6A is a schematic diagram illustrating an implementation procedure of a content element shared in call records according to the present disclosure.

FIG. 6B is a schematic diagram illustrating an implementation procedure of a content element shared in call records according to the present disclosure.

FIG. 6C is a schematic diagram illustrating an implementation procedure of a content element shared in call records according to the present disclosure.

FIG. 6D is a schematic diagram illustrating an implementation procedure of a content element shared in call records according to the present disclosure.

FIG. 7A is a schematic diagram illustrating an implementation procedure of a content element shared in a memo according to the present disclosure.

FIG. 7B is a schematic diagram illustrating an implementation procedure of a content element shared in a memo according to the present disclosure.

FIG. 7C is a schematic diagram illustrating an implementation procedure of a content element shared in a memo according to the present disclosure.

FIG. 8 is a block diagram of a device for sharing content according to one or more exemplary embodiments of the present disclosure.

FIG. 9 is a block diagram of a device for sharing content according to one or more exemplary embodiments of the present disclosure.

FIG. 10 is a block diagram of a device for sharing content according to one or more exemplary embodiments of the present disclosure.

Specific embodiments of the present disclosure have been shown in the above drawings. Hereinafter, the description with more details will be given. The drawings and text description are not to limit the scope of ideas of the present disclosure by any way, but by reference to specific embodiments, the concept of the present disclosure is explained to a skilled in the art.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items.

It is to be understood that, although terms such as “first” and “second” are used herein for describing various elements, these elements should not be limited by these terms. These terms are only used for distinguishing one element from another element. For example, a first sequencing criterion may also be called a second sequencing criterion, and similarly, the second sequencing criterion may also be called the first sequencing criterion, without departing from the scope of the present disclosure. Depending on the context, the term “if” used herein may be understood to mean “when” or “upon” or “in response to the determination of”.

The technical solutions provided in embodiments of the present disclosure are applied in an electronic apparatus. The electronic apparatus may be various kinds of terminals that are capable of performing touch operation by a touch screen, such as a smart phone, a tablet computer, a personal digital assistant (PDA) or other touch screen terminal with a processor and a display and output device.

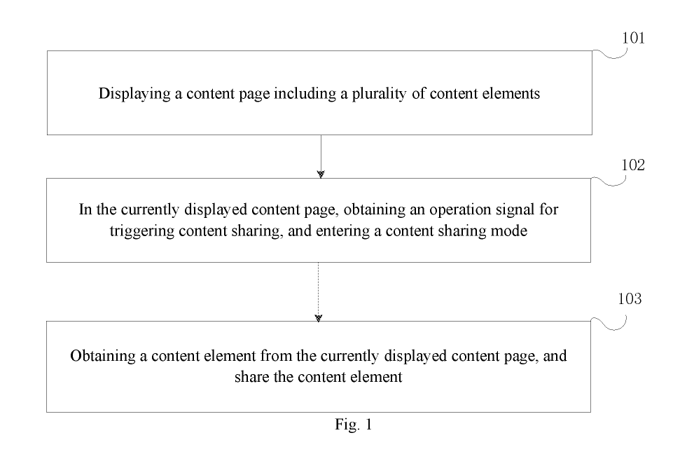

FIG. 1 is a flow chart of a method for sharing content according to an exemplary embodiment of the present disclosure. The method for sharing content is applied in an electronic apparatus with a touch screen. The method for sharing content may include following acts.

In block 101, a content page specified to open by a user is displayed. For example, the electronic apparatus may display a content page including a plurality of content elements on the touch screen.

In one or more embodiments, the content page may include a web page, an instant chat session page, a video playing page, a music playing page, or a page for displaying locally stored information, which are specified to open by the user. For example, the content page may be a page including a plurality of content elements. The content elements may include texts, drawings, HTTP links, or any other elements displayed in the content page.

In block 102, in the currently displayed content page, an operation signal of the user for triggering content sharing is obtained, and a content sharing mode is entered. For example, in the content page, the electronic apparatus obtains an operation signal of the user for triggering content sharing and enters a content sharing mode.

In one or more embodiments, obtaining an operation signal of the user for triggering content sharing, and entering a content sharing mode may include: detecting an operation gesture input by the user in the currently displayed page; and when the detected operation gesture is a preset operation gesture, obtaining the operation signal of the user for triggering content sharing, and entering the content sharing mode.

The preset operation gesture may include an operation gesture for triggering the currently displayed content page to be displayed as contracting inward from at least three corners of the touch screen. For example, the preset operation gesture may be an operation gesture for triggering the currently displayed content page to be displayed as contracting inward from four corners of the touch screen. The user may put at least three fingers on the at least three corners and then move the at least three fingers towards the content element to be shared. Thus, the electronic apparatus may enter the content sharing mode when detecting that at least three fingers are touching at least three corners of the touch screen and moves towards a center of the touch screen.

Alternatively or additionally, the preset operation may include using two fingers to touch the upper and lower boundaries of the touch screen and then moving the two fingers to the center of the touching screen. The preset operation may include other gestures involving at least two fingers starting on two diagonal corners of the touch screen and moving along the diagonal line.

In one or more embodiments, under the content sharing mode, the content elements in the currently displayed page are all in an editable state. For example, the user may perform operations such as clicking to select, clicking to view, copy and paste to a content element in the currently displayed page, and entrances of applications for sharing content may be provided to the user in the currently displayed page. So the user may select the content element in the currently displayed page, and then share the selected content element by the displayed sharing entrances.

In block 103, a content element selected by the user from the currently displayed content page is obtained, and the content element is shared. For example, the electronic apparatus may obtain a selection gesture identifying at least one content element from the plurality of content elements on the content page. And the electronic apparatus may share the at least one content element when detecting that the at least one content element are dragged to a predetermined area on the touch screen.

In one or more embodiments, sharing the content element includes: displaying icons of applications installed in the electronic apparatus for the user to share content; and dragging the content element based on the displayed icons of the applications to realize sharing the content element.

The content element may include at least one of: text content, a picture, a link address, an audio, a video, and other type of content.

In an embodiment, dragging the content element based on the displayed icons of the applications to realize sharing the content element includes: detecting a dragging operation to the content element; if the dragging operation to the content element is detected, dynamically displaying the content element according to the dragging operation; when detecting the content element is moved to an icon of a target application in the displayed icons of the applications, sharing the content element in the target application.

The target application includes a communication application or a text editing application.

In an embodiment, when detecting the content element is moved to an icon of a target application in the displayed icons of the applications, sharing the content element in the target application includes: when detecting the content element is moved to the icon of the target application in the displayed icons of the applications, opening the target application; when the target application is the communication application, selecting a contact to share from the target application, and sharing the content element to the contact; when the target application is the text editing application, inserting the content element to a target editing page of the text editing application.

In summary, in technical solutions of the present disclosure, the operation signal of the user for triggering content sharing is obtained in the content page, the content sharing mode is entered, the content element selected by the user from the content page is obtained, and the content element is shared. By the operation signal for triggering content sharing, triggering to enter the content sharing mode in the content page, the user may freely select and share the content element in the content page under the content sharing mode.

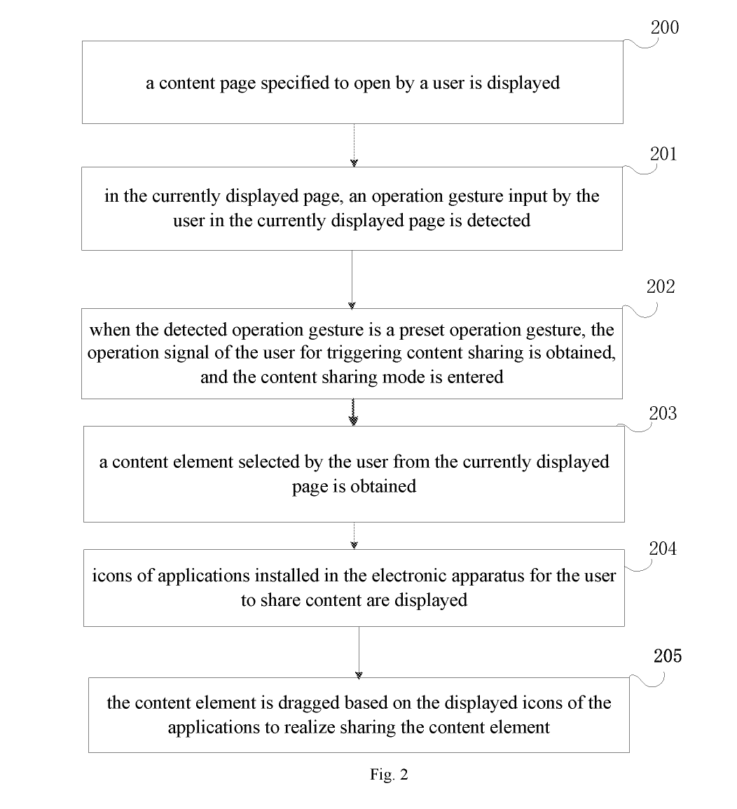

Referring to FIG. 2, FIG. 2 is a flow chart of a method for sharing content according to an exemplary embodiment of the present disclosure. The method is applied to the above electronic apparatus, and may include following blocks.

In block 200, a content page specified to open by a user is displayed.

In one or more embodiments, the content page may include a web page, an instant chat session page, a video playing page, a music playing page, or a page for displaying locally stored information, which are specified to open by the user. The page for displaying locally stored information may include a contact list page, a call records page, or a picture library, etc.

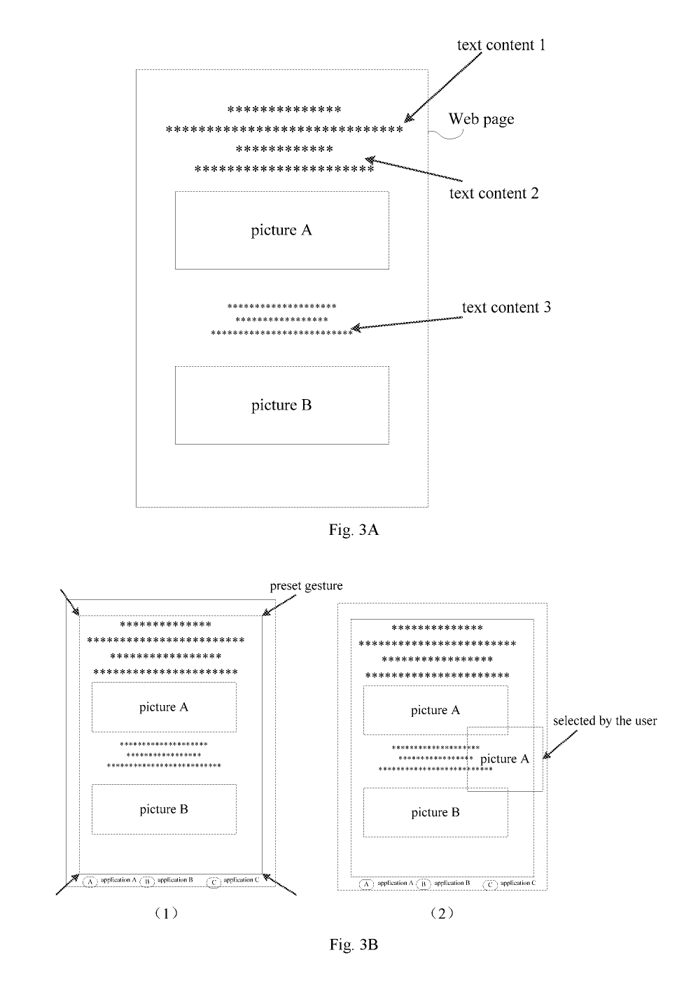

The web page is taken as an example of the content page specified to open by the user in this embodiment for illustrating. As shown in FIG. 3A, an interface of a web page is exemplarily given, which includes text content 1, text content 2, text content 3, a picture A, and a picture B.

In block 201, in the currently displayed content page, an operation gesture input by the user in the currently displayed content page is detected.

Implementation principles of touch screen technology are briefly introduced here. A touch screen includes a touch detecting assembly and a touch screen controller, in which the touch detecting assembly is mounted in the front of a display screen, configured to detect a touch position of the user (when human body touches the touch screen similar to an electrostatic induction sheet, a current induction signal may be generated, and the touch detecting assembly may know a touch point of the user by sensing the current induction signal), then related touch information is transferred to the touch screen controller. When receiving the touch information transferred from the touch detecting assembly, the touch screen controller converts the touch information into a coordinate of the touch point, and transfers the coordinate of the touch point to a CPU (Central Processing Unit) to process. Meanwhile, the touch screen controller may also receive and execute instructions sent from the CPU.

Based on the above implementation principles of touch screen technology, when a touch operation is performed by the user on the touch screen of the electronic apparatus, the electronic apparatus may detect the operation gesture of the user based on changes of the current induction signals of the touch screen.

In block 202, when the detected operation gesture is a preset operation gesture, the operation signal of the user for triggering content sharing is obtained, and the content sharing mode is entered.

In an embodiment, the user may preset an operation gesture for triggering to enter the content sharing mode according to own habits. An operating system records this operation gesture. The preset operation gesture may be a preset sliding trace or an operation gesture for triggering a certain operation.

In one or more embodiments, the preset operation gesture may include an operation gesture that involves at least three fingers on at least three convers of the display screen and contracting the at least three fingers inward from the at least three corners of the display screen, which may trigger the currently displayed content page to enter the content sharing mode.

When the operation signal of the user for triggering content sharing is obtained, the content sharing mode is triggered to enter, and the user may select and share the content element in the currently displayed page under the content sharing mode. The content element for the user to select may include at least one of text content, a picture, a link address, an audio and a video. For example, the user may click a content element that is laid out based on a page layout in the currently displayed page, such as a certain picture, a certain paragraph of text, a video or a link address in the currently displayed page.

In block 203, a content element selected by the user from the currently displayed content page is obtained.

In one or more embodiments, the content element selected by the user from the currently displayed page is determined based on the selecting operation of the user, and the content element selected by the user is processed, which include: extracting and highlighting the content element selected by the user from the currently displayed page; or extracting and editing the content element selected by the user from the currently displayed page, and highlighting the edited content element.

Referring to FIG. 3B, a schematic diagram illustrating a user triggering the currently displayed page to enter a content sharing mode is exemplarily given. As shown in FIG. 3B (1), when detecting the operation gesture of the user for triggering the currently displayed page to be displayed as contracting inward from four corners of the display screen, the currently displayed page is triggered, such as the displayed page in FIG. 3A is triggered to be displayed as contracting inward from four corners of the display screen, and then the content sharing mode is entered. As shown in FIG. 3B (2), the content element selected by the user from the currently displayed page (the picture A selected by the user) is extracted and highlighted, so as to perform sharing operation to the content element selected (the picture A). Under the content sharing mode, the icons of the applications for the user to share are displayed in a bottom region of the display screen of the electronic apparatus, such as the application A, the application B and the application C shown in FIG. 3B (1) and FIG. 3B (2).

Here, the user may put one finger on the content element and the other three fingers contracting inward from three corners of the display screen. The three fingers may move toward the content element so that the electronic apparatus selects the content element.

In an embodiment, before sharing the content element selected by the user, the content element selected by the user may be edited. For example, when the content element is a picture, the displaying size, layout and other displaying state of the selected picture may be edited. When the content element is text content, a reediting operation may be performed to the text content, such as adding text description, deleting some words, or changing font style, font size or font color etc. For example, the picture A selected by the user in FIG. 3B (2) may be cut to obtain a picture A whose size meets requirement of the user, and then, the picture A after cut is shared.

In block 204, icons of applications installed in the electronic apparatus for the user to share content are displayed.

In one or more embodiments, after obtaining the operation signal of the user for triggering content sharing, the content sharing mode is triggered to enter. Under the content sharing mode, the currently displayed page may be displayed as contracting inward from four corners of the display screen by a preset scale, and the icons of the applications installed in the electronic apparatus for the user to share content are displayed at the bottom of the display screen, as shown in FIG. 3B (1) and FIG. 3B (2).

In an embodiment, types of applications installed in the electronic apparatus are detected. Under the content sharing mode, icons of applications that satisfy a preset type condition in the applications installed in the electronic apparatus are arranged and displayed in order in a preset region of the display screen (such as the bottom region of the electronic display screen). The applications that satisfy the preset type condition are applications in which the sharing operation may be performed to the content element. For example, communication applications or text edit applications installed in the electronic apparatus may be satisfied.

Displaying icons of applications installed in the electronic apparatus for the user to share content may mean follows. The icons are displayed in an order according to installation time of the applications that satisfy the preset type condition, for example, applications with earlier installation time than other applications of the applications installed in the electronic apparatus may be arranged to be displayed first. Or the icons may be displayed in an order according to using times or using frequency of the applications that satisfy the preset type condition, for example, applications with more usage times or with higher usage frequency than other applications of the applications installed in the electronic apparatus may be arranged to be displayed first.

In block 205, the content element is dragged based on the displayed icons of the applications to realize sharing the content element.

In an embodiment, under the content sharing mode, after displaying the icons of the applications for the user to share content, the user may realize sharing the content element by an operation of dragging the selected content element.

In one or more embodiments, dragging the content element based on the displayed icons of the applications to realize sharing the content element includes: detecting a dragging operation to the content element; if the dragging operation to the content element is detected, dynamically displaying the content element according to the dragging operation; when detecting the content element is moved to an icon of a target application in the displayed icons of the applications, sharing the content element in the target application.

The target application may include but be not limited to a communication application or a text editing application.

The text editing application may be an office application software such as word and PPT, or an editing software for a memo, a note and the like. The communication application may be an instant messaging application, a short messaging service (SMS), a telephone application, or a communication tool such as social networking service (SNS) application software.

In one or more embodiments, when detecting the content element is moved to an icon of a target application in the displayed icons of the applications, sharing the content element in the target application includes: when detecting the content element is moved to the icon of the target application in the displayed icons of the applications, opening the target application; when the target application is the communication application, selecting a contact to share from the target application, and sharing the content element to the contact; when the target application is the text editing application, inserting the content element to a target editing page of the text editing application.

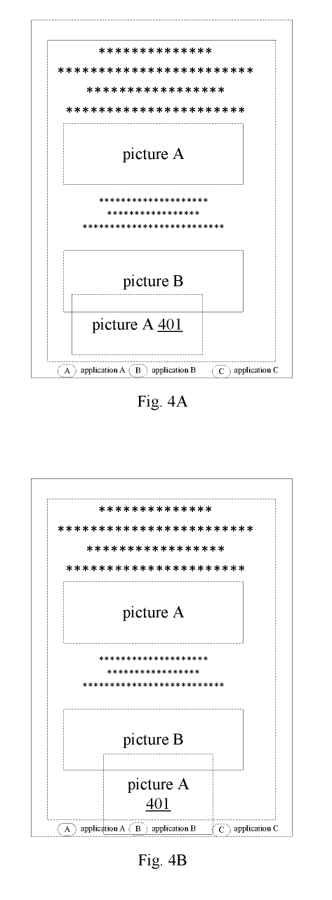

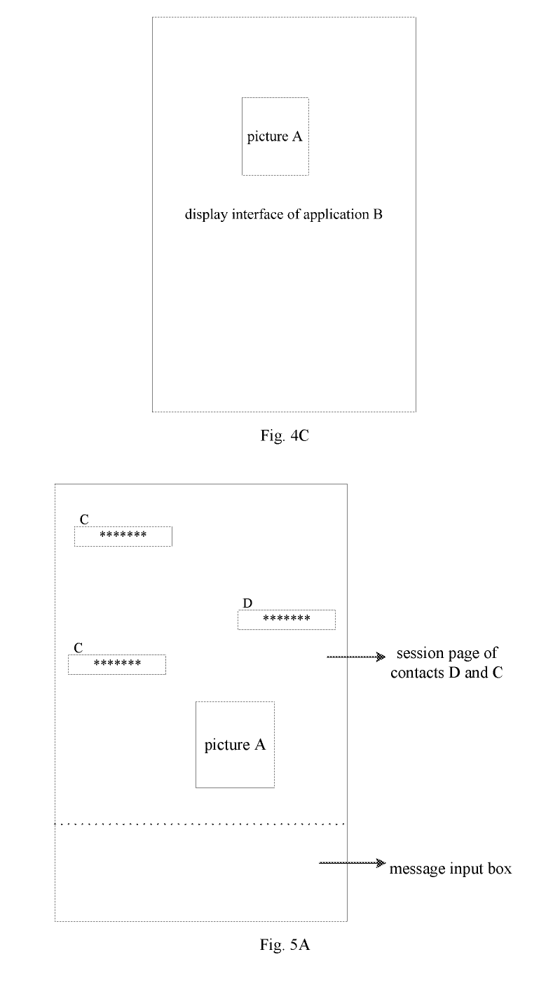

Referring to FIG. 4A to FIG. 4C, schematic diagrams illustrating an operation of dragging a content element to a target application in displayed applications to share are exemplarily given. As shown in FIG. 4A, when detecting the dragging operation to the content element from the user, the content element 401 (such as the picture A) is displayed dynamically according to the dragging operation. The dynamically displayed content element 401 may be displayed in a semi-opaque fashion in a smaller size. Additionally or alternatively, the dynamically displayed content element 401 may be surrounded with a dashed contour when moving from the original position to the target application. As shown in FIG. 4A, the original picture A does not disappear while the content element 401 is moving.

FIG. 4B is a schematic diagram illustrating a second operation of dragging a content element to a target application in displayed applications to share according to one or more exemplary embodiments of the present disclosure. The content element 401 is moved to overlap at least partially with the icon of the target application, which is located at the bottom of the display window. When the electronic apparatus determines that the content element 401 is overlapping with a plurality of target applications, the electronic apparatus may determine that the one that has the most overlapping area to be the one the user intended to open and share the content. The electronic apparatus may select the target application by at least one of the following acts: increasing the size of the icon corresponding to the target application, changing the color of the icon of the target application, and applying other preset animation effects to the icon of the target application.

FIG. 4C is a schematic diagram illustrating a third operation of dragging a content element to a target application in displayed applications to share according to one or more exemplary embodiments of the present disclosure. When the content element is moved to the icon of the target application in the displayed icons of the applications and the target application is confirmed, the target application is opened as shown in FIG. 4C. Accordingly, the user may perform a sharing operation to the content element in the opened target application. Here, there is no need to quit the current application and open the target application manually to share the content element.

The target application may include one or more of the following applications: a communication application, a social network application, a messaging application, a text editing application, or any application the user may select to add to the list of target applications in the setup of the system.

In an embodiment, when the target application is a communication application, the user may select a contact to share in a conversation session page with a contact, a contact list page, or a call records page of the communication application, and share the content element to the selected contact.

In an embodiment, sharing the content element to a contact of the communication application may include: opening the session page with a contact in the communication application, and sending the content element to a contact of the session page; or opening the contact list page of the communication application, selecting a contact from the contacts, and sending the content element to the selected contact; or opening the call records page of the communication application, selecting a contact from the call records page, and sending the content element to the selected contact.

In an embodiment, sharing the content element to a contact of the communication application may further include: dragging the content element to a conversation session page with a contact, a contact list page, or a call records page of the opened target application, further dragging the content element to a preset position of the conversation session page, the contact list page, or the call records page, and sending the content element to a contact corresponding to the preset position. Herein, sending the content element to a contact of the communication application refers to sending an original picture of the content element to the contact of the communication application.

In an embodiment, the preset position may be a message input box area of the conversation session page, an entry position of a contact in the contact list page, or an entry position of a call record in the call records page.

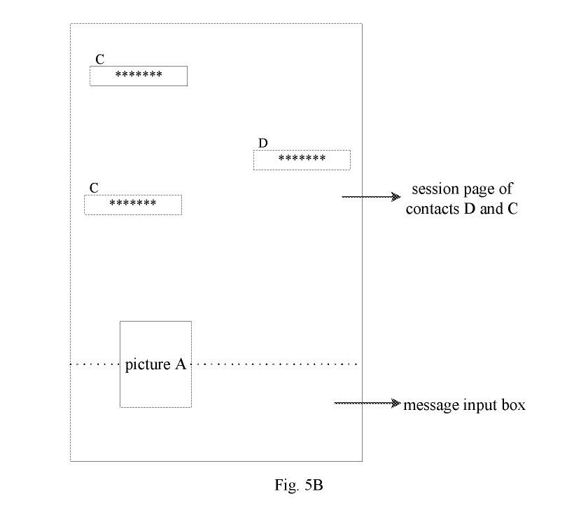

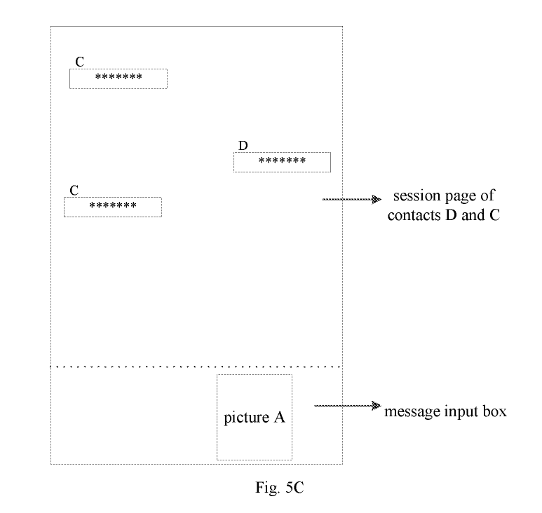

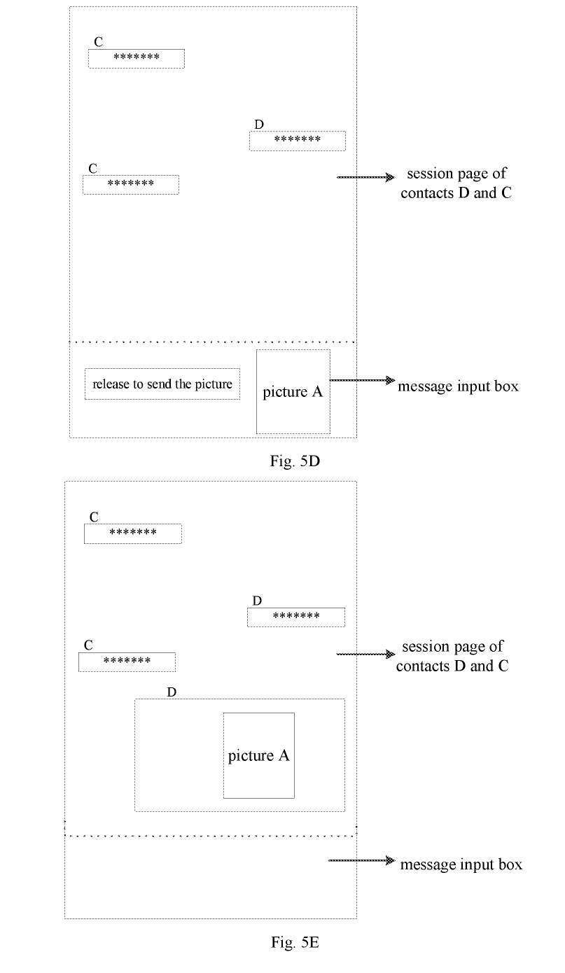

For example, in an embodiment, when a conversation session page of the communication application is opened, when detecting the content element is moved to the message input box of the conversation session page of the communication application, the content element may be send to a contact of the current session. FIG. 5A to FIG. 5E all are schematic diagrams illustrating an example implementation procedure of a content element shared in a conversation session page according to an exemplary embodiment of the present disclosure. The content element is dragged to a display interface of the opened target application B, in which the display interface of the application B is a conversation session page, and the content element (such as the picture A) is still displayed in the conversation session page, as shown in FIG. 5A.

As shown in FIG. 5B, after detecting the dragging operation to the content element from the user, the electronic apparatus moves the content element to the current display interface according to the dragging operation. When the content element is dragged to the message input box of the conversation session page, if detecting the user releases the dragging operation to the content element, the content element is input to the message input box, referring to FIG. 5C. If detecting a request to send the content element in the message input box, the content element may be sent to a contact of the current session, referring to FIG. 5E, realizing an operation of sharing the content element to the contact.

In an embodiment, before sharing the content element to the contact, the user is informed to perform a picture sharing operation, as shown in FIG. 5D. For example, the electronic apparatus may display a message including words of “release to send the picture” while detecting that the user is performing the dragging operation. Here, the message is intended to inform the user that releasing the dragging operation to the content element may initiate a sending operation of the content element.

In an embodiment, the implementation process of the above FIG. 5A to FIG. 5E may be simplified. When detecting the content element is dragged to the message input box of the conversation session page, the user is directly informed whether to send the picture, such as “release to send the picture.” When detecting the user releasing the dragging operation to the content element, the content element is directly sent to the contact of the current session.

For example, in an embodiment, if a contact list page of the communication application is opened, when detecting the content element is dragged to an entry position of a contact in the contact list page, the content element is sent to the contact. In an embodiment, if a call records page of the communication application is opened, when detecting the content element is dragged to an entry position of a call record in the call records page, the content element is sent to a contact corresponding to the call record.

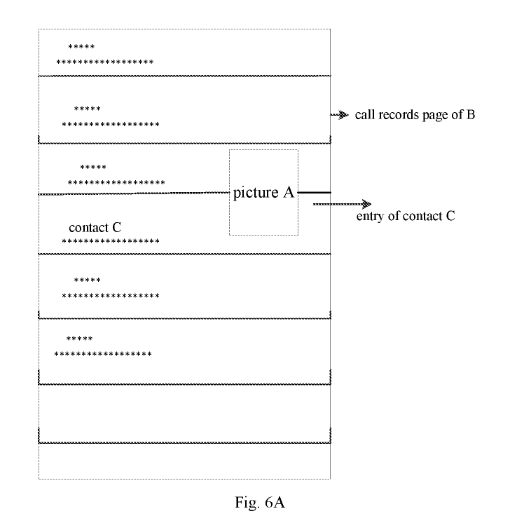

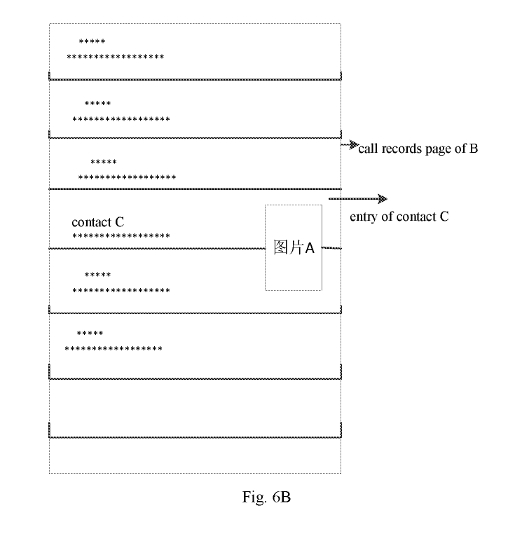

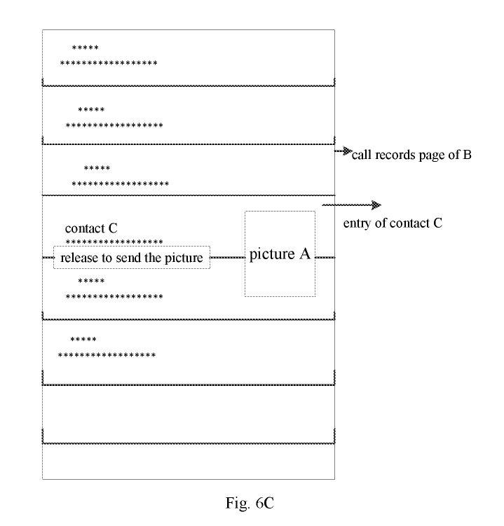

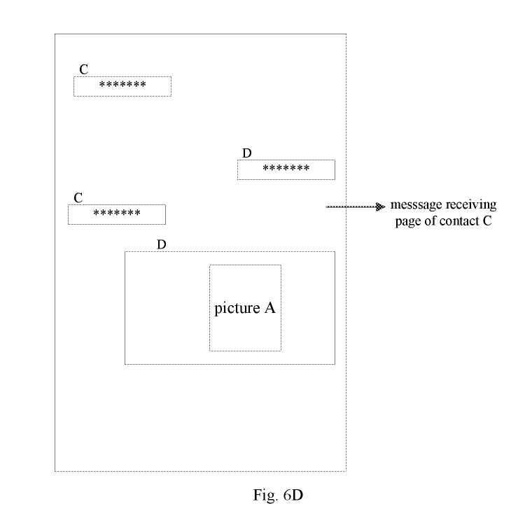

FIG. 6A to FIG. 6D all are schematic diagrams illustrating an implementation procedure of a content element shared in call records according to an exemplary embodiment of the present disclosure. Here, a display interface of the application B is a call records page. The content element is dragged to the target application B, and then the target application B is opened. As shown in FIG. 6A, and the content element is still displayed in the call records page. As shown in FIG. 6B, after detecting the dragging operation to the content element from the user, the content element is moved in the current display interface according the dragging operation. As shown in FIG. 6D, when the content element is dragged to an entry of a contact in the contact list page, if detecting the user releases the dragging operation to the content element, the content element is sent to a contact corresponding to the call record Thus, the electronic apparatus may realize an operation of sharing the content element to the contact.

In one or more embodiments, before sharing the content element to the contact, the user is informed to perform a picture sharing operation, as shown in FIG. 6C, words of “release to send the picture” is informed to the user, to inform the user that releasing the dragging operation to the content element may realize a sending operation of the content element.

In an embodiment, implement process of the above FIG. 6A to FIG. 6D may be simplified. When detecting the content element is dragged to the entry of a call record in the call records page, the user is directly informed whether to send the picture, such as “release to send the picture.” When detecting the user releasing the dragging operation to the content element, the content element is directly sent to the contact corresponding to the call record.

When the target application is other communication applications, the way of sending the content element to a contact of the communication applications is similar to the above that in the message session page or in the call records page, which should not be described in detail herein.

In an embodiment, when the target application is a text editing application, after opening the text editing application, the content element may be inserted to a target position of the text editing application by dragging the content element, realizing sharing the content element.

In an embodiment, when the target application is a text editing application, inserting the content element to a target editing page of the text editing application may be follows. When the target editing page is a memo editing page, if detecting the content element is dragged to a text row of the memo editing page, the content element is inserted to the text row of the memo editing page. Or, when the target editing page is an office editing software, if detecting the content element is dragged to a position of a text editing page, the content element is inserted to the position.

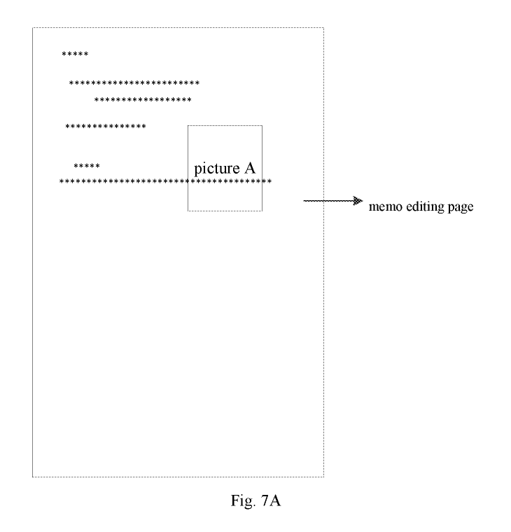

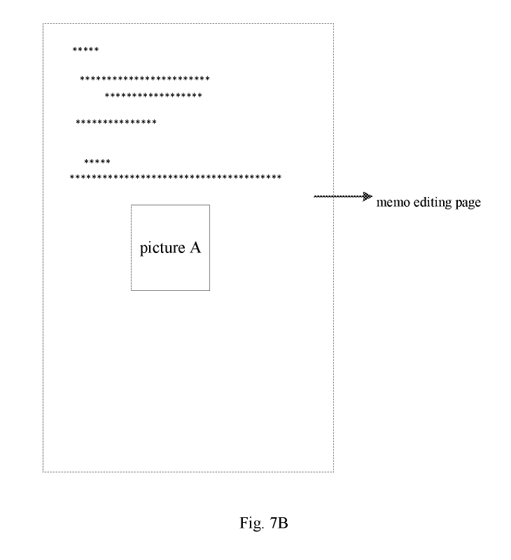

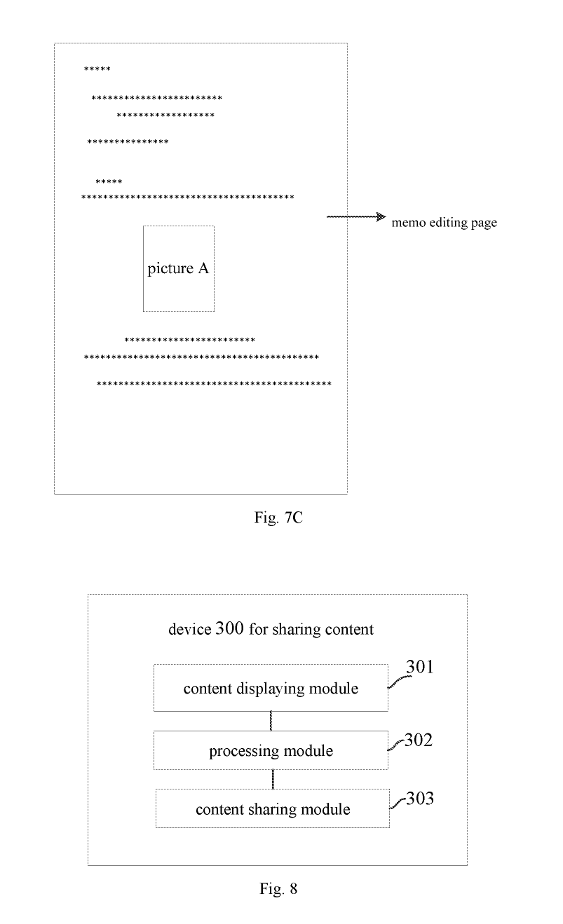

FIG. 7A to FIG. 7C illustrate an example implementation procedure of a content element shared in a memo according to one or more exemplary embodiments of the present disclosure. The content element is dragged to a display interface of the opened target application B, in which the display interface of the application B is a memo editing page, and the content element is still displayed in the memo editing page, as shown in FIG. 7A. After detecting the dragging operation to the content element from the user, the content element is moved in the current display interface according the dragging operation, process of which may refer to FIG. 7B. When the content element is dragged to a row of the memo editing page, if detecting the user releases the dragging operation to the content element, the content element is inserted to the row of the memo editing page, referring to FIG. 7C, realizing an operation of sharing the content element.

When the target application is other text editing applications, the way of inserting the content element to the text editing page is similar to the above that inserting the content element to the memo editing page, which should not be described in detail herein.

In an embodiment, before performing a sharing operation to the content element, the method further includes: informing the user whether to share the content element, so as to avoid the accidentally touching operation.

Above exemplary descriptions are in the case that the content element selected to share by the user is a picture. When the content element selected to share by the user is text content, a video, an audio, or a link address, it is similar to above exemplary descriptions, which should not be described in detail.

In summary, in technical solution of the present disclosure, the operation signal of the user for triggering content sharing is obtained in the currently displayed page, the content sharing mode is entered, the content element selected by the user from the currently displayed page is obtained, and the content element is shared. By the operation signal for triggering content sharing, triggering to enter the content sharing mode in the currently displayed page, the user may freely select and share the content element in the currently displayed page under the content sharing mode.

Followings are device embodiments of the present disclosure, which may be used to execute the method embodiments of the present disclosure. Please refer to the method embodiments for the details not disclosed in the device embodiments.

FIG. 8 is a block diagram of a device 300 for sharing content according to an exemplary embodiment of the present disclosure. The device 300 for sharing content is applied in an electronic apparatus with a touch screen. The device 300 for sharing content may include a content displaying module 301, a processing module 302 and a content sharing module 303.

The content displaying module 301 is configured to display a content page specified to open by a user.

The processing module 302 is configured to obtain an operation signal of the user for triggering content sharing in the currently displayed page, and to enter a content sharing mode.

The content sharing module 303 is configured to obtain a content element selected by the user from the currently displayed page, and to share the content element.

In summary, in technical solutions of the present disclosure, the operation signal of the user for triggering content sharing is obtained in the currently displayed page, the content sharing mode is entered, the content element selected by the user from the currently displayed page is obtained, and the content element is shared. By the operation signal for triggering content sharing, triggering to enter the content sharing mode in the currently displayed page, the user may freely select and share the content element in the currently displayed page under the content sharing mode.

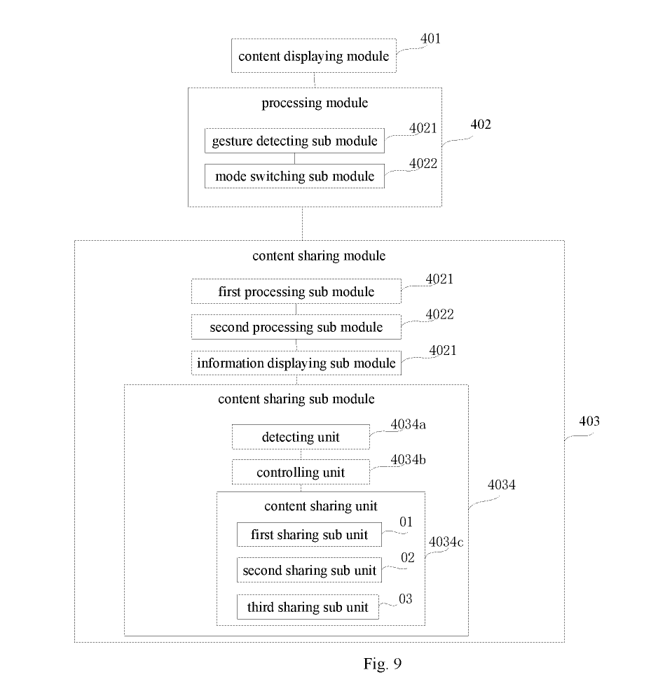

FIG. 9 is a block diagram of a device for sharing content according to another exemplary embodiment of the present disclosure. The device for sharing content is applied in an electronic apparatus with a touch screen. The device for sharing content may include: a content displaying module 401, a processing module 402, and a content sharing module 403.

The content displaying module 401 is configured to display a content page specified to open by a user.

In one or more embodiments, the content page may include a web page, an instant chat session page, a video playing page, a music playing page, a music playing page, or a page for displaying locally stored information, which are specified to open by the user.

The processing module 402 is configured to obtain an operation signal of the user for triggering content sharing in the currently displayed page, and to enter a content sharing mode.

The processing module 402 may include a gesture detecting sub module 4021 and a mode switching sub module 4022.

The gesture detecting sub module 4021 is configured to detect an operation gesture input by the user in the currently displayed page.

The mode switching sub module 4022 is configured to obtain the operation signal of the user for triggering content sharing, and to enter the content sharing mode, when the detected operation gesture is a preset operation gesture.

The preset operation gesture may be an operation gesture for triggering the currently displayed page to be displayed as contracting inward from four corners of a display screen.

The content sharing module 403 is configured to obtain a content element selected by the user from the currently displayed page, and to share the content element.

In an embodiment, the content sharing module 403 may include at least one of: a first processing sub module 4031 and a second processing sub module 4032. The first processing sub module 4031 is configured to extract and highlight the content element selected by the user from the currently displayed page. The second processing sub module 4032 is configured to extract and edit the content element selected by the user from the currently displayed page, and to highlight the edited content element.

In an embodiment, the content sharing module 403 may further include an information displaying sub module 4033 and a content sharing sub module 4034. The information displaying sub module 4033 is configured to display icons of applications installed in the electronic apparatus for the user to share content. The content sharing sub module 4034 is configured to drag the content element based on the displayed icons of the applications to realize sharing the content element.

The content element may include at least one of text content, a picture, a link address, an audio and a video.

In one or more embodiments, the content sharing sub module 4034 may include a detecting unit 4034a, a controlling unit 4034b, and a content sharing unit 4034c. The detecting unit 4034a is configured to detect a dragging operation to the content element. The controlling unit 4034b is configured to dynamically display the content element according to the dragging operation, if the dragging operation to the content element is detected. The content sharing unit 4034c is configured to share the content element in the target application, when detecting the content element is moved to an icon of a target application in the displayed icons of the applications.

The target application includes a communication application or a text editing application.

When implemented, the content sharing unit 4034c may include a first sharing sub unit 01, a second sharing sub unit 02 and a third sharing sub unit 03.

The first sharing sub unit 01 is configured to open the target application, when detecting the content element is moved to the icon of the target application in the displayed icons of the applications.

The second sharing sub unit 02 is configured to select a contact to share from the target application, and to share the content element to the contact, when the target application is the communication application.

The third sharing sub unit 03 is configured to insert the content element to a target editing page of the text editing application, when the target application is the text editing application.

In summary, in technical solutions of the present disclosure, the operation signal of the user for triggering content sharing is obtained in the currently displayed content page, the content sharing mode is entered, the content element selected by the user from the currently displayed content page is obtained, and the content element is shared. By the operation signal for triggering content sharing, triggering to enter the content sharing mode in the currently displayed content page, the user may freely select and share the content element in the currently displayed content page under the content sharing mode.

With respect to the device in the above embodiments, specific manners for respective modules performing operations have been described in detail in the related method embodiments and detailed descriptions thereof are omitted herein.

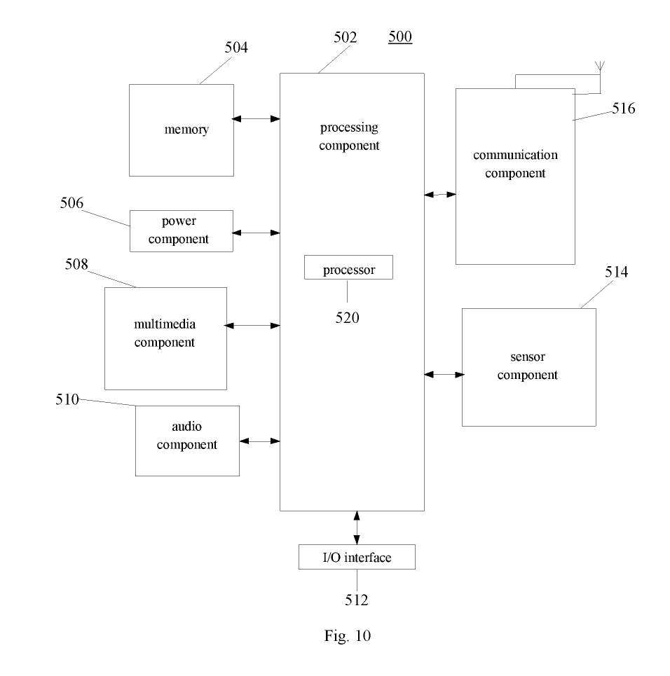

FIG. 10 shows a block diagram of a device 500 for sharing content according to an exemplary embodiment of the present disclosure. For example, the device 50 may be a mobile phone, a tablet computer or other electronic apparatus with a touch sreen.

Referring to FIG. 10, the device 500 may include the following one or more components: a processing component 502, a memory 504, a power component 506, a multimedia component 508, an audio component 510, an Input/Output (I/O) interface 512, a sensor component 514, and a communication component 516.

The processing component 502 typically controls overall operations of the electronic device 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the electronic device 500. Examples of such data include instructions for any applications or methods operated on the electronic device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the electronic device 500. The power component 506 may include a power management system, one or more power sources, and any other components associated with the generation, management, and distribution of power in the electronic device 500.

The multimedia component 508 includes a screen providing an output interface between the electronic device 500 and the user, and the four corner of the screen are rounded. In some embodiments, the screen may include a liquid crystal display (LCD) and a press panel (TP). If the screen includes the press panel, the screen may be implemented as a press screen to receive input signals from the user. The press panel includes one or more press sensors to sense presses, swipes, and other gestures on the press panel. The press sensors may not only sense a boundary of a press or swipe action, but also sense a duration time and a pressure associated with the press or swipe action. In some embodiments, the multimedia component 508 includes a front camera and/or a rear camera. The front camera and/or the rear camera may receive external multimedia data while the electronic device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone (MIC) configured to receive an external audio signal when the electronic device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface for the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the electronic device 500. For instance, the sensor component 514 may detect an open/closed status of the electronic device 500 and relative positioning of components (e.g. the display and the keypad of the electronic device 500. The sensor component 514 may also detect a change in position of the electronic device 500 or of a component in the electronic device 500, a presence or absence of user contact with the electronic device 500, an orientation or an acceleration/deceleration of the electronic device 500, and a change in temperature of the electronic device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate wired or wireless communication between the electronic device 500 and other devices. The electronic device 500 can access a wireless network based on a communication standard, such as WIFI, 2G, or 3G, or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the electronic device 500 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The electronic device 500 may use the circuitries in combination with the other hardware or software components for performing the above described methods. Each module, sub-module, unit, or sub-unit disclosed above may be implemented at least partially using the one or more circuitries.

In exemplary embodiments, there is also provided a non-transitory computer readable storage medium including instructions, such as the memory 504 including instructions. The instructions may be performed by the processor 520 of the electronic device 500 so as to realize the method for generating information. For example, the non-transitory computer-readable storage medium may be a ROM, a RAM, a CD-ROM, a magnetic tape, a floppy disc, an optical data storage device, and the like.

A non-transitory computer readable storage medium is provided, when the instructions in the storage medium are performed by the processor of the device 500, the device 500 may execute the above method for sharing content.

It will be appreciated that the present disclosure is not limited to the exact construction that has been described above and illustrated in the accompanying drawings, and that various modifications and changes can be made without departing form the scope thereof. It is intended that the scope of the disclosure only be limited by the appended claims.

What is claimed is:

1. A method for sharing content, comprising:
displaying, by an electronic apparatus comprising a touch screen, a content page comprising a plurality of content elements on the touch screen;
in the content page, obtaining, by the electronic apparatus, an operation signal for triggering content sharing, and entering a content sharing mode; and
obtaining a selection gesture identifying at least one content element from the plurality of content elements on the content page, and sharing the at least one content element when detecting that the at least one content element are dragged to a predetermined area on the touch screen.

2. The method according to claim 1, wherein obtaining the operation signal for triggering content sharing and entering the content sharing mode comprises:
detecting an operation gesture input by a user in the content page; and
when the detected operation gesture is a preset operation gesture, obtaining the operation signal of the user for triggering content sharing, and entering the content sharing mode.

3. The method according to claim 2, wherein, the preset operation gesture comprises an operation gesture for contracting at least three fingers inward from at least three corners of the touch screen.

4. The method according to claim 1, wherein obtaining the selection gesture identifying at least one content element from the plurality of content elements on the page comprises one of the following:
extracting and highlighting the content element selected by a user from the content page; and
extracting and editing the content element selected by the user from the content page, and highlighting the edited content element.

5. The method according to claim 4, wherein sharing the at least one content element comprises:
displaying icons of applications installed in the electronic apparatus for the user to share content; and
dragging the content element based on the displayed icons of the applications to realize sharing the content element.

6. The method according to claim 1, wherein the content element comprises at least one of text content, a picture, a link address, an audio, and a video.

7. The method according to claim 5, wherein dragging the content element based on the displayed icons of the applications to realize sharing the content element comprises:
detecting a dragging operation to the content element;
when the dragging operation to the content element is detected, dynamically displaying the content element according to the dragging operation; and
when detecting the content element is moved to an icon of a target application in the displayed icons of the applications, sharing the content element in the target application.

8. The method according to claim 7, wherein the target application comprises at least one of: a communication application, a text editing application, a social network application.

9. The method according to claim 8, wherein when detecting the content element is moved to an icon of a target application in the displayed icons of the applications, sharing the content element in the target application comprises:
when detecting the content element is moved to the icon of the target application in the displayed icons of the applications, opening the target application;
when the target application is the communication application, selecting a contact to share from the target application, and sharing the content element to the contact; and
when the target application is the text editing application, inserting the content element to a target editing page of the text editing application.

10. A device for sharing content, comprising:
a processor;
a touch screen in communication with the processor; and
a memory for storing instructions executable by the processor;
wherein the processor is configured to:
instruct the touch screen to display a content page comprising a plurality of content elements on the touch screen;
obtain an operation signal of a user for triggering content sharing in the content page, and enter a content sharing mode; and
obtain a selection gesture identifying at least one content element from the plurality of content elements on the content page, and share the content element when detecting that the at least one content element are dragged to a predetermined area on the touch screen.

11. The device according to claim 10, wherein the processor is configured to obtain the operation signal of the user for triggering content sharing and to enter a content sharing mode by acts of:
detecting an operation gesture input by the user in the content page; and
when the detected operation gesture is a preset operation gesture, obtaining the operation signal of the user for triggering content sharing, and entering the content sharing mode.

12. The device according to claim 11, wherein the preset operation gesture comprises an operation gesture for contracting at least three fingers inward from at least three corners of the touch screen.

13. The device according to claim 10, wherein the processor is configured to obtain a content element selected by the user from the content page by one of the following acts:
extracting and highlighting the content element selected by the user from the content page; and
extracting and editing the content element selected by the user from the content page, and highlighting the edited content element.

14. The device according to claim 13, wherein the processor is configured to share the content element by acts comprising:
displaying icons of applications installed in the device for the user to share content; and
dragging the content element based on the displayed icons of the applications to realize sharing the content element.

15. The device according to claim 10, wherein the content element comprises at least one of text content, a picture, a link address, an audio and a video.

16. The device according to claim 14, wherein the processor is configured to drag the content element based on the displayed icons of the applications to realize sharing the content element by acts comprising:
detecting a dragging operation to the content element;
when the dragging operation to the content element is detected, dynamically displaying the content element according to the dragging operation; and
when detecting the content element is moved to an icon of a target application in the displayed icons of the applications, sharing the content element in the target application.

17. The device according to claim 16, wherein the target application comprises a communication application or a text editing application.

18. The device according to claim 17, wherein the processor is configured to share the content element in the target application when detecting the content element is moved to an icon of a target application in the displayed icons of the applications, by acts comprising:
when detecting the content element is moved to the icon of the target application in the displayed icons of the applications, opening the target application;
when the target application is the communication application, selecting a contact to share from the target application, and sharing the content element to the contact; and
when the target application is the text editing application, inserting the content element to a target editing page of the text editing application.

19. A non-transitory computer-readable storage medium having stored therein instructions that, when executed by a processor of a device comprising a touch screen, causes the device to perform acts comprising:
displaying a content page comprising a plurality of content elements on the touch screen;
in the content page, obtaining an operation signal of a user for triggering content sharing, and entering a content sharing mode; and
obtaining a content element selected by the user from the content page, and sharing the content element.

20. The non-transitory computer-readable storage medium according to claim 19, wherein obtaining the operation signal of the user for triggering content sharing and entering a content sharing mode comprises:
detecting an operation gesture input by the user in the content page; and
when the detected operation gesture is a preset operation gesture, obtaining the operation signal of the user for triggering content sharing, and entering the content sharing mode.
